(19) United States
(12) Patent Application Publication
(10) Pub. No.: US 2024/0221516 A1
(43) Pub. Date: Jul. 4, 2024

(54) TERMINAL APPARATUS

(71) Applicant: TOYOTA JIDOSHA KABUSHIKI KAISHA, Toyota-shi (JP)

(72) Inventor: Tatsuro HORI, Edogawa-ku (JP)

(73) Assignee: TOYOTA JIDOSHA KABUSHIKI KAISHA, Toyota-shi (JP)

(21) Appl. No.: 18/522,808

(22) Filed: Nov. 29, 2023

(30) Foreign Application Priority Data
Dec. 28, 2022 (JP) 2022-212653

(51) Int. Cl. G09B 5/02; G06T 7/00; G06T 11/00; G06T 11/60; G09B 11/00

(52) U.S. Cl. CPC G09B 5/02; G06T 7/97; G06T 11/001; G06T 11/60; G09B 11/00; G06T 2207/10024; G06T 2207/20221; G06T 2210/62

(57) ABSTRACT

A terminal apparatus includes a controller. The controller is configured to generate a third image by processing and combining a first image and/or a second image based on a result of comparison between the first image and the second image. The controller is configured to display the third image on a display apparatus. The first image includes at least a character or an illustration. The second image, which is different from the first image, includes at least a character or an illustration.

### CROSS-REFERENCE TO RELATED APPLICATION

This application claims priority to Japanese Patent Application No. 2022-212653 filed on Dec. 28, 2022, the entire contents of which are incorporated herein by reference.

### TECHNICAL FIELD

The present disclosure relates to a terminal apparatus.

### BACKGROUND

Technology for projecting a result of correction or the like is known. For example, Patent Literature (PTL) 1 describes that a part to be corrected in comparison with reference information is projected as a correction information image, as a result of determining, by a program that determines a work result, data of captured image when a sheet of paper on which calligraphy is written is captured as a subject.

### CITATION LIST

### Patent Literature

PTL 1: JP 2005-293290 A

### SUMMARY

Technology for making it easier to see a result of correction or the like is required.

It would be helpful to provide technology for making it easier to see a result of correction or the like.

A terminal apparatus according to an embodiment of the present disclosure includes a controller configured to:
generate a third image by processing and combining a first image and/or a second image based on a result of comparison between the first image and the second image, the first image including at least a character or an illustration and the second image, which is different from the first image, including at least a character or an illustration; and
display the third image on a display apparatus.

According to an embodiment of the present disclosure, technology for making it easier to see a result of correction or the like can be provided.

### BRIEF DESCRIPTION OF THE DRAWINGS

In the accompanying drawings:

FIG. 1 is a block diagram of a system according to an embodiment of the present disclosure;

FIG. 2 is a sequence diagram illustrating operation procedure of the system according to the embodiment of the present disclosure; and

FIG. 3 is a diagram illustrating an example of a third image.

### DETAILED DESCRIPTION

An embodiment of the present disclosure will be described below, with reference to the drawings.

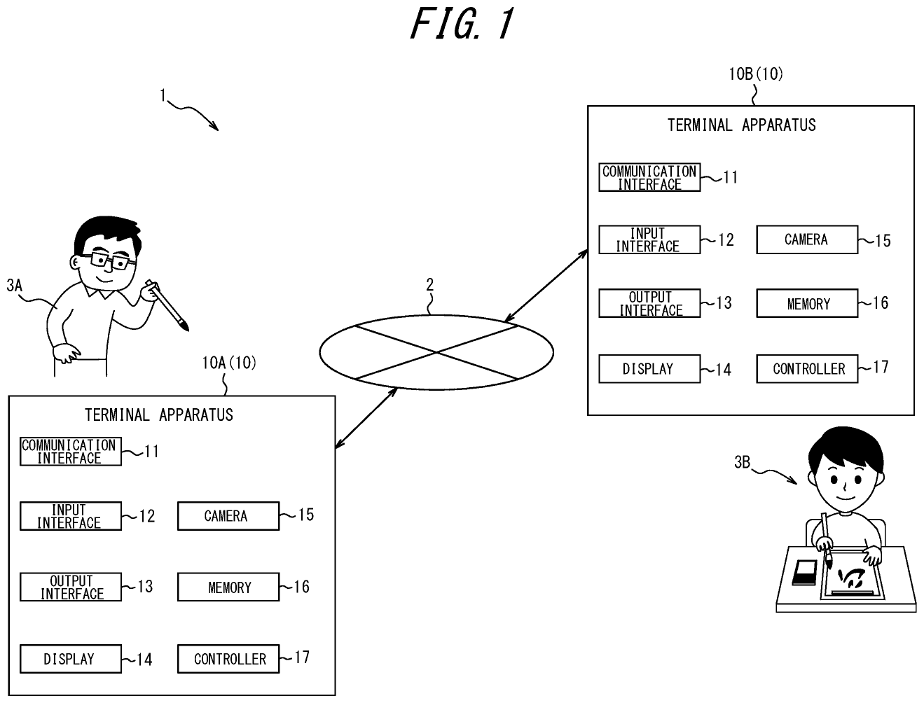

As illustrated in FIG. 1, a system 1 includes a terminal apparatus 10A and a terminal apparatus 10B. Hereinafter, the terminal apparatuses 10A and 10B are also collectively referred to as “terminal apparatuses 10” unless particularly distinguished. The system 1 includes two terminal apparatuses 10. However, the system 1 may include two or more terminal apparatuses 10.

The terminal apparatus 10A can communicate with the terminal apparatus 10B via a network 2. The network 2 may be any network including a mobile communication network, the Internet, or the like.

The system 1 is applied to correcting calligraphy. However, the application of the system 1 is not limited to correcting calligraphy, as described below.

The terminal apparatus 10A is used by a user 3A. The user 3A is a calligraphy teacher. The user 3A corrects letters written by a user 3B using the terminal apparatus 10A.

The terminal apparatus 10B is used by a user 3B. The user 3B is a student of calligraphy. The user 3B is taught calligraphy by a user 3A using the terminal apparatus 10B.

Each of the terminal apparatuses 10 is, for example, a terminal apparatus such as a desktop personal computer (PC), a tablet PC, a notebook PC, or a smartphone.

### (Configuration of Terminal Apparatus)

As illustrated in FIG. 1, the terminal apparatus 10 includes a communication interface 11, an input interface 12, an output interface 13, a display 14, a camera 15, a memory 16, and a controller 17. The terminal apparatus 10 includes a display apparatus. The display apparatus includes the display 14 and output interface 13 projectors.

The communication interface 11 is configured to include at least one communication module for connection to the network 2. For example, the communication module is, for example, a communication module compliant with a standard such as a wired local area network (LAN) standard or a wireless LAN standard, or a mobile communication standard such as the Long Term Evolution (LTE) standard, the 4th Generation (4G) standard, or the 5th Generation (5G) standard.

The input interface 12 is capable of accepting an input from a user. The input interface 12 is configured to include at least one interface for input that is capable of accepting an input from the user. The interface for input is, for example, a physical key, a capacitive key, a pointing device, a touch screen integrally provided with a display of the display 14, a microphone, or the like.

The output interface 13 can output data. The output interface 13 is configured to include at least one interface for output that is capable of outputting the data. The interface for output includes a speaker, a projector, or the like. In the present embodiment, the output interface 13 consists of a projector.

The display 14 is capable of displaying data. The display 14 comprises, for example, a display, etc. The display is, for example, a liquid crystal display (LCD), an organic electro-luminescent (EL) display, or the like.

The camera 15 is capable of imaging subjects to generate captured images. The camera 15 is, for example, a visible light camera. The camera 15 captures continuous images of a subject at any frame rate, for example. The captured image produced by the camera 15 is, for example, a color (RGB) image. However, the captured image generated by the camera 15 may be a monochrome image.

The memory 16 is configured to include at least one semiconductor memory, at least one magnetic memory, at least one optical memory, or a combination of at least two of these. The memory 16 may function as, for example, a main memory, an auxiliary memory, or a cache memory. The memory 16 stores data to be used for operations of the terminal apparatus 10 and data obtained by the operations of the terminal apparatus 10.

The controller 17 is configured to include at least one processor, at least one dedicated circuit, or a combination thereof. The processor is, for example, a general purpose processor such as a Central Processing Unit (CPU) or a Graphics Processing Unit (GPU), or a dedicated processor that is dedicated to a specific process. The controller 17 executes processes related to the operations of the terminal apparatus 10 while controlling the components of the terminal apparatus 10.

### (Operations of System)

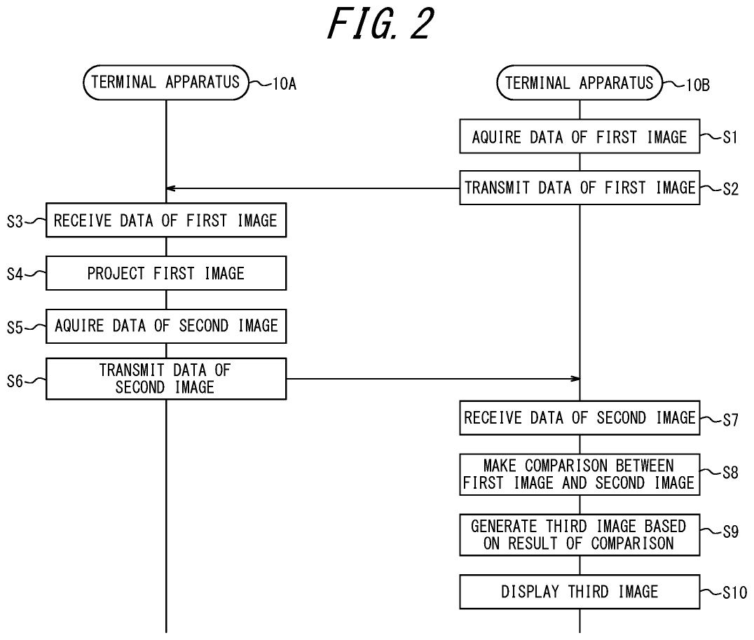

FIG. 2 is a sequence diagram illustrating an operation procedure of the system 1 illustrated in FIG. 1. The operation procedure illustrated in FIG. 2 is an example of a display method according to the present embodiment. When the user 3B writes a letter on the half-sheet of paper placed in front of him, the system 1 begins the processing of step S1. Alternatively, when the controller 17 of the terminal apparatus 10B receives an input of correction instructions from the user 3B by the input interface 12, the system 1 may begin the processing of step S1.

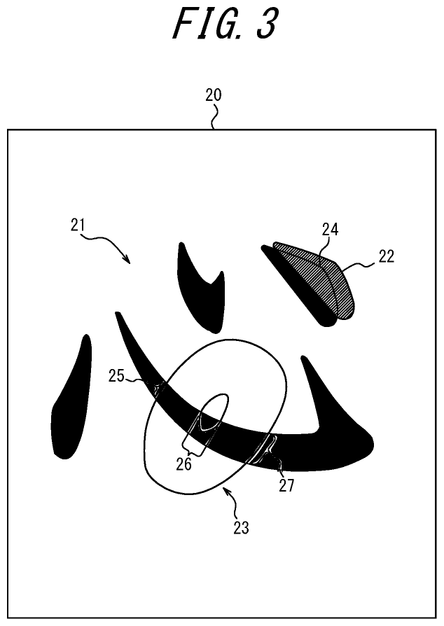

In step S1, in the terminal apparatus 10B, the controller 17 acquires the data of the first image that contains at least text or illustrations. In the present embodiment, the controller 17 acquires the data of the image of the characters written by the user 3B on the half-sheet of paper as the data of the first image. However, depending on the application to which the system 1 is applied, the first image may contain only text, only illustrations, or both text and illustrations. Hereafter, when no particular distinction is made between text and illustrations contained in the first image, they will also be described as “subject to correction”. As an example of processing, the controller 17 acquires data of an image of a half-sheet of paper placed in front of the user 3B by having the camera 15 capture it as a subject. The controller 17 performs image processing on the data of the half-sheet image to acquire the data of the first image containing the characters written by the user 3B. In the example in FIG. 3 below, the first image includes the word “heart” 21.

In the processing of step S2, in the terminal apparatus 10B, the controller 17 controls the communication interface 11 to transmit the data of the first image to the terminal apparatus 10A via the network 2.

In the processing of step S3, in the terminal apparatus 10A, the controller 17 controls the communication interface 11 to receive the data of the first image from the terminal apparatus 10B via the network 2.

In the process of step S4, in the terminal apparatus 10A, the controller 17 projects the first image onto a half sheet of paper placed in front of the user 3A by the projector of the output interface 13. This process projects the characters written by the user 3B onto the half-sheet of paper placed in front of the user 3A. The user 3A corrects the characters written by the user 3B projected on a half-sheet of paper. In the example in FIG. 3 below, the user 3A corrects the word “heart” 21 written by the user 3B by writing the illustration 22 of a dot and the illustration 23 of a double circle on a half sheet of paper.

In the processing of step S5, in the terminal apparatus 10A, the controller 17 acquires the data of the second image. The second image is a different image from the first image and contains at least text or illustrations. In the present embodiment, the controller 17 acquires the data of the image of characters, etc. that the user 3A wrote on a half-sheet of paper by correction as the data of the second image. However, depending on the application to which the system 1 is applied, the second image may contain only text, only illustrations, or both text and illustrations. Hereafter, when no particular distinction is made between text and illustrations contained in the second image, these will also be described as “results of correction”. As an example of processing, the controller 17 acquires data of an image of a half-sheet of paper placed in front of the user 3A by having the camera 15 capture it as a subject. The controller 17 performs image processing on the data of the half-sheet image to acquire the data of the second image including the results of correction. In the example in FIG. 3 below, the second image includes an illustration 22 of a dot and an illustration 23 of a double circle. The illustration 22 of a dot may be interpreted as text because it is part of the text. A double circle means that the student is highly rated in the study.

In the processing of step S6, in the terminal apparatus 10A, the controller 17 controls the communication interface 11 to transmit the data of the second image to the terminal apparatus 10B via the network 2. The controller 17 may send the data of the half-sheet image to the terminal apparatus 10B along with the data of the second image.

In the processing of step S7, in the terminal apparatus 10B, the controller 17 controls the communication interface 11 to receive the data of the second image from the terminal apparatus 10A via the network 2. In the terminal apparatus 10B, the controller 17 may receive the data of the half-sheet image along with the data of the second image.

In step S8, in the terminal apparatus 10B, the controller 17 compares the first image with the second image. In comparing the first image to the second image, the controller 17 may compare any element related to the display mode.

For example, the controller 17 may compare the luminance value of the subject of correction in the first image with the luminance value of the correction result in the second image. In this case, the result of comparing the first image with the second image is the difference in luminance between the subject of correction in the first image and the correction result in the second image.

For example, the controller 17 may compare the brightness of the subject of correction in the first image with the brightness of the correction result in the second image. In this case, the result of comparing the first image with the second image is the brightness difference between the subject of correction of the first image and the correction result of the second image.

For example, the controller 17 may compare the position of the subject of correction in the first image with the position of the correction result in the second image. In this case, the result of comparing the first image with the second image is an overlapping portion between a subject of correction of the first image and a result of correction in the second image.

In the process of step S9, the terminal apparatus 10B, the controller 17 generates a third image by processing and combining at least one of the first and second images based on the result of comparison between the first image and the second image. Here, the controller 17 may process at least one of the first image and the second image to make the result of correction of the second image easier to see based on the result of comparison between the first image and the second image. The controller 17 may process the overlapping portion between the subject of correction of the first image and the result of correction in the second image. If the controller 17 receives the data of the image of the half sheet of paper in the process of step S7, it may composite the first image and the second image by referring to the data of the received half sheet of paper. As an example, the controller 17 may combine the first and second images so that the positional relationship between the subject of correction of the first image and the correction result of the second image in the third image is the same as the positional relationship between the subject of correction and the correction result in the received half sheet image.

For example, the controller 17 may change the colors of the first image and/or the color of the second image based on a result of comparison between the first image and the second image. The controller 17 may change the color of at least one of the first and second images if the difference in brightness between the subject of correction of the first image and the correction result of the second image is less than the first threshold. The first threshold may be set in consideration of the legibility of the color of the text or illustration in the display by the display apparatus. Alternatively, the controller 17 may change the color of at least one of the first and second images if the luminance difference between the subject of correction of the first image and the correction result of the second image is less than the second threshold. The second threshold may be set in consideration of the legibility of the color of the text or illustration in the display by the display apparatus. The controller 17 may change the color of the first image and/or the color of the second image so that the color of the first image to be corrected and the color of the second image correction result are in exact opposite positions on the color circle. The controller 17 may change only the color of the second image correction result received from the terminal apparatus 10B's communication partner, the terminal apparatus 10A, to a more visible color. Visible colors may be set based on the colors that the average human perceives as easy to see. For the part that changes color, the controller 17 may change the color of all of the subject of correction in the first image or all of the results of correction in the second image, or it may change the color of some of the subject of correction in the first image or some of the results of correction in the second image. When changing some colors, the controller 17 may only change the overlapping portion between the subject of correction of the first image and the result of correction in the second image.

For example, the controller 17 may increase the transparency of the first image and/or transparency of the second image based on the result of the comparison between the first image and the second image. The controller 17 may increase the transparency of the only overlapping portion between the subject of correction of the first image and the result of correction in the second image in the first image and/or in the second image. The controller 17 may increase the transparency of a portion of at least one of the first image and second image so that the transparency of the portion of the image that increases transparency is higher than the original transparency of that portion. The controller 17 may determine the degree of increased transparency based on the visibility of the subject of correction or correction result in the display by the display apparatus. The controller 17 may increase the transparency of the subject of correction of the first image only if the brightness difference between the subject of correction of the first image and the correction result of the second image is less than the first threshold or if the brightness difference between the subject of correction of the first image and the correction result of the second image is less than the second threshold. By increasing the transparency of only the subject of correction in the first image, the result of correction in the second image can be made more visible.

In step S10, the terminal apparatus 10B, the controller 17 displays the third image on the display apparatus. In the present embodiment, the controller 17 displays the third image on the display 14 as a display apparatus. However, the display apparatus is not limited to the display 14. As another example, the display apparatus may be a projector of the output interface 13. In this case, the controller 17 projects the third image onto a desk or other object by the projector of the output interface 13.

By executing the process of step S10, the third image 20 as shown in FIG. 3 is displayed on the display 14 of the terminal apparatus 10B. The third image 20 includes the word “heart” 21, an illustration of a dot 22, and an illustration of a double circle 23. A character 21 is a character included in the first image. In other words, the character 21 is a character written by the user 3B on a half-sheet of paper. The illustrations 22 and 23 are the results of the correction contained in the second image. In other words, the illustrations 22 and 23 were written by the user 3A on a half sheet of paper through correction. In the third image 20, the text 21 and the illustration 22 overlap at portion 24. In the third image 20, the text 21 and the illustration 23 overlap at portions 25, 26, and 27. The transparency of portions 24-27 of character 21 is raised above the original transparency of portions 24-27 by the controller 17 process. This configuration makes it easier to see the 22 illustrations of dots and the 23 illustrations of double circles.

Here, in the process of step S2, the terminal apparatus 10B may send the data of the captured image of the half sheet of paper in front of the user 3B to the terminal apparatus 10A instead of the first image. In this case, the terminal apparatus 10A may receive the data of the half-sheet image from the terminal apparatus 10B in the process of step S3. In the process of step S4, the controller 17 of the terminal apparatus 10A may acquire the data of the first image including the characters written by the user 3B by executing image processing on the data of the received image of the half sheet of paper. In the process of step S4, the controller 17 of terminal apparatus 10A may project the acquired first image onto a half sheet of paper placed in front of the user 3A by the projector of the output interface 13.

In the process of step S6, the terminal apparatus 10A may send the data of the captured image of the half sheet of paper in front of the user 3A to the terminal apparatus 10B instead of the second image. In this case, the terminal apparatus 10A does not need to perform the process of step S5. In the process of step S7, the terminal apparatus 10B may receive the data of the half-sheet image from terminal device 10A. In the process of step S7, the controller 17 of the terminal apparatus 10B may acquire the data of the second image including the result of correction by the user 3A by executing image processing on the data of the received image of the half-sheet of paper.

Thus, in this form of the terminal apparatus 10B according to the present embodiment, the controller 17 generates a third image by processing and combining at least one of the first and second images based on the result of comparison between the first image and the second image. This configuration makes it easier to see the results of correction of the second image in the third image. Here, a method of presenting the results of correction of the second image to the user 3B by projecting the second image onto a half sheet of paper in front of the user 3B using a projector or other means is also possible. However, this method may make it difficult to see the results of correction in the second image due to reasons such as the darker color of the letters in the user 3B that are actually written on the half-sheet of paper. In contrast, in the present embodiment, the controller 17 generates a third image and displays the generated third image on a display apparatus, rather than projecting the second image onto a half sheet of paper in front of the user 3B by a projector or other means. This configuration makes it easier to see the results of correction of the second image than if the second image were projected onto a half sheet of paper in front of the user 3B.

Thus, the present embodiment can provide technology for making it easier to see a result of correction.

Furthermore, in the terminal apparatus 10B according to the present embodiment, the controller 17 may change the color of at least one of the first images and second images based on the result of comparison between the first and second images. The process of changing colors can be carried out, for example, by simply replacing the colors. Thus, this configuration simplifies the process of processing the first images and second images.

In the terminal apparatus 10B according to the present embodiment, the controller 17 may change the color of the first image and/or the color of the second image so that the color of the first image to be corrected and the color of the second image correction result are in exact opposite positions on the color circle. This configuration makes the results of correction of the second image more visible in the third image.

In the terminal apparatus 10B according to the present embodiment, the controller 17 may increase the transparency of at least one of the first images and second images based on the result of comparison between the first and the second images. This configuration makes it possible to make the results of correction of the second image more visible in the third image without changing the colors of the first images and the second images. By not changing the colors of the first images and second images, the originality of the first and second images can be maintained. In addition, the process of increasing transparency is a relatively easy process in image processing. This simplifies the process of processing the first images and the second images.

While the present disclosure has been described with reference to the drawings and examples, it should be noted that various modifications and revisions may be implemented by those skilled in the art based on the present disclosure. Accordingly, such modifications and revisions are included within the scope of the present disclosure. For example, functions or the like included in each component, each step, or the like can be rearranged without logical inconsistency, and a plurality of components, steps, or the like can be combined into one or divided.

For example, in the embodiment described above, the student who receives calligraphy correction is assumed to be one of the users 3B. However, there may be more than one student receiving calligraphy correction.

For example, in the embodiment described above, the system 1 is described as being applied to correct calligraphy. However, the application of the system 1 is not limited to the correction of calligraphy. The system 1 may be applied to any correction being made. As another example, the system 1 may be applied to correcting painting or calculation drills, etc.

For example, in the embodiment described above, the terminal apparatus 10A and the terminal apparatus 10B are described as communicating directly with each other via the network 2. However, the terminal apparatus 10A and the terminal apparatus 10B may communicate via a server apparatus.

For example, an embodiment in which a general purpose computer functions as the terminal apparatuses 10 according to the above embodiment can also be implemented. Specifically, a program in which processes for realizing the functions of the terminal apparatus 10 according to the above embodiment are written may be stored in a memory of a general purpose computer, and the program may be read and executed by a processor. Accordingly, the present disclosure can also be implemented as a program executable by a processor, or a non-transitory computer readable medium storing the program.

Examples of some embodiments of the present disclosure are described below. However, it should be noted that the embodiments of the present disclosure are not limited to these.

[Appendix 1] A terminal apparatus comprising a controller configured to:
generate a third image by processing and combining a first image and/or a second image based on a result of comparison between the first image and the second image, the first image including at least a character or an illustration and the second image, which is different from the first image, including at least a character or an illustration; and
display the third image on a display apparatus.

[Appendix 2] The terminal apparatus according to appendix 1, wherein the controller is configured to change a color of the first image and/or a color of the second image based on the result of the comparison between the first image and the second image.

[Appendix 3] The terminal apparatus according to appendix 1 or 2, wherein the controller is configured to change the color of the first image and/or the color of the second image so that a color of the character or the illustration included in the first image and a color of the character and the illustration included in the second image are in exact opposite positions on a color circle.

[Appendix 4] The terminal apparatus according to any one of appendices 1 to 3, wherein the controller is configured to increase transparency of the first image and/or transparency of the second image based on the result of the comparison between the first image and the second image.

[Appendix 5] The terminal apparatus according to any one of appendices 1 to 4, wherein the result of the comparison between the first image and the second image includes an overlapping portion between the character or the illustration included in the first image and the character or the illustration included in the second image, and the controller is configured to process the overlapping portion.

[Appendix 6] The terminal apparatus according to any one of appendices 1 to 5, wherein the first image includes a subject of correction, and the second image includes a result of correction.

[Appendix 7] A display method comprising:
generating a third image by processing and combining a first image and/or a second image based on a result of comparison between the first image and the second image, the first image including at least a character or an illustration and the second image, which is different from the first image, including at least a character or an illustration; and
displaying the third image on a display apparatus.

[Appendix 8] A program configured to cause a computer to execute operations, the operations comprising:
generating a third image by processing and combining a first image and/or a second image based on a result of comparison between the first image and the second image, the first image including at least a character or an illustration and the second image, which is different from the first image, including at least a character or an illustration; and
displaying the third image on a display apparatus.

1. A terminal apparatus comprising a controller configured to:
generate a third image by processing and combining a first image and/or a second image based on a result of comparison between the first image and the second image, the first image including at least a character or an illustration and the second image, which is different from the first image, including at least a character or an illustration; and
display the third image on a display apparatus.

2. The terminal apparatus according to claim 1, wherein the controller is configured to change a color of the first image and/or a color of the second image based on the result of the comparison between the first image and the second image.

3. The terminal apparatus according to claim 2, wherein the controller is configured to change the color of the first image and/or the color of the second image so that a color of the character or the illustration included in the first image and a color of the character and the illustration included in the second image are in exact opposite positions on a color circle.

4. The terminal apparatus according to claim 1, wherein the controller is configured to increase transparency of the first image and/or transparency of the second image based on the result of the comparison between the first image and the second image.

5. The terminal apparatus according to claim 1, wherein the result of the comparison between the first image and the second image includes an overlapping portion between the character or the illustration included in the first image and the character or the illustration included in the second image, and the controller is configured to process the overlapping portion.
